(19) United States
(12) Patent Application Publication
(10) Pub. No.: US 2015/0322326 A1
(43) Pub. Date: Nov. 12, 2015

(54) PULSE POWER DRILLING FLUID AND METHODS OF USE

(71) Applicants: Donald C. Van Slyke, Richmond, TX (US); Stephen Joseph Miller, San Francisco, CA (US); Saleh Ali Elomari, Fairfield, CA (US)

(72) Inventors: Donald C. Van Slyke, Richmond, TX (US); Stephen Joseph Miller, San Francisco, CA (US); Saleh Ali Elomari, Fairfield, CA (US)

(73) Assignee: CHEVRON U.S.A. INC., San Ramon, CA (US)

(21) Appl. No.: 14/695,942

(22) Filed: Apr. 24, 2015

Related U.S. Application Data
(60) Provisional application No. 61/990,202, filed on May 8, 2014.

(51) Int. Cl. C09K 8/32; E21B 7/15

(52) U.S. Cl. CPC C09K 8/32; E21B 7/15; C09K 2208/12

(57) ABSTRACT

Pulse power drilling fluids comprising a base fluid solution of a low viscosity ester and an alkylene carbonate in an amount that is soluble in the ester are provided. The pulse power drilling fluids provide excellent properties for use in pulse-power drilling, e.g., a high dielectric constant, a high dielectric strength, lower viscosity and lower conductivity than current pulse-power drilling fluids. Methods of using the pulse power drilling fluids are also described.

### RELATED APPLICATIONS

This non-provisional patent application claims the benefit of and priority from U.S. Provisional Application No. 61/990,202 filed May 8, 2014, which is related to U.S. patent application Ser. No. 13/682,542, titled “Monoester-Based Lubricants and Methods of Making Same,” filed on Nov. 20, 2012; U.S. patent application Ser. No. 13/973,619, titled “Biologically-Derived Monoesters As Drilling Fluids,” filed on Aug. 22, 2013; and U.S. patent application Ser. No. 13/973,754 titled “Method of Using Biologically-Derived Monoesters As Drilling Fluids,” filed on Aug. 22, 2013. The contents of the foregoing applications are hereby incorporated herein by reference.

### FIELD OF THE INVENTION

This invention relates to ester-based pulse power drilling fluid compositions and their methods for use in pulse power drilling, wherein the drilling fluid has a low viscosity, a high dielectric constant, high dielectric strength and low conductivity.

### BACKGROUND

An electrocrushing system or pulse power drilling system can include a drilling apparatus that utilizes an electrical spark, or plasma, inside rock or other hard substrate to fracture the rock or hard substrate. The system typically comprises a housing incorporating a set of electrodes. The electrical spark or plasma is created by switching a high voltage pulse across two electrodes immersed in drilling fluid that insulates the electrodes from each other to direct the arc inside the rock. Without being bound to theory, the current flowing through the conduction path rapidly heats the rock and vaporizes a small portion. The rapid formation of the vapor creates pressure that fractures the rock or hard substrate. Examples of pulse power drilling methods and apparatus are described in U.S. patent publication nos. 20060037779 and 20070137893, the contents of each of which are incorporated by reference in their entirety.

Drilling fluid for use with pulse power drilling is distinct from conventional rotary drilling fluids, and in particular, must provide high dielectric strength to provide high electric fields at the electrodes, low conductivity to provide low leakage current during the delay time from application of the voltage until the arc ignites in the rock, and high dielectric constant to shift a higher proportion of the electric field into the rock near the electrodes. Examples of pulse power drilling methods, fluids and apparatus are described in U.S. patent publication no. 20060037516, the contents of which are incorporated by reference in its entirety.

In conventional rotary bit drilling, a drilling fluid is used as a lubricant. Pulse power drilling, on the other hand, uses fundamentally different technology than rotary bit drilling to break apart a substrate and the drilling fluid used in pulse power drilling serves other functions. Pulse power drilling fluid is pumped through the downhole tool at the bottom of the wellbore being drilled and up through the annulus between the drill string and the wellbore. The pulse power drilling fluid brings drill cuttings upward through the annulus and provides a hydrostatic head to prevent a blowout. Additionally, the pulse power drilling fluid must be an insulating fluid with high dielectric constant (relative permittivity) to shift electric fields away from the liquid and into the rock in the region of the electrodes. The pulse power drilling fluid needs to be characterized by low conductivity to minimize leakage current.

Alternative pulse power drilling fluids based on petroleum provide a high dielectric strength and low conductivity, but do not have high relative permittivity. Propylene carbonate has a high dielectric constant and moderate dielectric strength, but also has high conductivity (approximately twice that of deionized water) making it unsuitable base oil for pulse power applications.

In one example, water has been used as the fluid for a mineral disintegration process. In another example, an ultra-thick castor oil-based drilling fluid, disclosed in U.S. patent Ser. No. 11/208,766 titled “High Permittivity Fluid” can be used in the mineral disintegration process. However, there are significant drawbacks with these known approaches. A water-based pulse power drilling fluid provides a high dielectric constant, but has high conductivity, creating high electrode charge losses. A castor oil/alkylene carbonate based drilling fluid results in high circulating pressure in the wellbore, increased lost circulation, and high oil retention on cuttings.

Also the hydrolytic stability of castor oil is poor due to the use of non-esterified vegetable oil. This results in even further increase in viscosity when formation water, high pH and high temperatures are encountered during drilling. Hence, there is a need for a pulse power drilling fluid having high dielectric strength, high dielectric constant, low conductivity, low viscosity, and good hydrolytic stability.

### SUMMARY OF THE INVENTION

Pulse power drilling fluid compositions provided herein comprise a base oil solution of an alkylene carbonate and an ester having a kinematic viscosity at a temperature of 40° C. of about 40 cSt or less, wherein the alkylene carbonate is present in an amount that is soluble in the ester and in an amount that imparts the electrical properties necessary to render the pulse power drilling fluid suitable for use with pulse power drilling techniques. In further embodiments, the pulse power drilling fluid has one or more of the following characteristics: i) a dielectric constant of about 6 or greater, ii) a conductivity of about 10⁻⁵ mho/cm or less; and iii) a dielectric strength of about 300 kV/cm or greater. In a particular embodiment, the drilling fluid has i) a dielectric constant of about 6 or greater, ii) a conductivity of about 10⁻⁵ mho/cm or less; and iii) a dielectric strength of about 300 kV/cm or greater.

Additional embodiments disclosed herein are directed to a method of pulse power drilling a borehole in a substrate comprising: providing an electrocrushing drill comprising a drill bit that receives a pulsed electric current; introducing the drilling fluid into the borehole and through the drill bit; and breaking the substrate with the pulsed electric current.

### BRIEF DESCRIPTION OF THE DRAWINGS

FIG. 1 is a graph that displays the effect of base solvent type on the dielectric constant in accordance with certain example embodiments.

### DETAILED DESCRIPTION

### Definitions and Terms

The following terms will be used throughout the specification and will have the following meanings unless otherwise indicated.

The phrase “pulse power drilling” is used herein to describe methods of drilling, such as in a subterranean formation or in a mineral substrate (e.g., rock), using a drill bit that receives a pulsed electric current. Examples of pulse power drilling apparatus and methods include those described in the U.S. patent publication nos. 2007/0137893, 2006/0037779, and 2006/0037516, each of which are incorporated herein in their entirety.

As used herein, “bit” and “drill bit” are defined as the working portion or end of a tool that performs a function such as, but not limited to, cutting, drilling, boring, fracturing, or breaking action on a substrate (e.g., rock). The pulse power drill bit comprises a set of electrodes which produce pulsed electromagnetic waves to “explode” the rock in situ in the presence of a liquid as opposed to, or optionally, in addition to drilling the rock in a conventional manner with a rotary drill bit. As used herein, the term “pulse power” refers to the release of stored electrical energy (e.g., in a capacitor or inductor) into a substrate so that a pulse of current at high peak power is produced. “Electrocrushing” (“EC”) is a term also used to describe the process of using pulse power to pass a pulsed electrical current through a substrate so that the substrate is “crushed” or “broken.”

The phrase “drilling fluid” is used herein to refer to liquid fluids, fluid mixtures and mixtures of fluids and solids (as solid suspensions, mixtures and emulsions of liquids, gases and solids) used in operations to drill boreholes into the earth.

The phrase “base oil solution” is used herein to refer to a mixture of i) a base oil solvent and ii) a solute present in an amount that is soluble in the base oil solvent, wherein the base oil solution forms the continuous phase into which drilling additives are mixed to form a pulse power drilling fluid. A base oil solution for a pulse power drilling fluid in accordance with the present disclosure includes an alkylene carbonate (solute) and an ester (solvent).

The phrases “dielectric constant” or “relative permittivity” are used according to their standard meaning and are used interchangeably herein to refer to a dimensionless number that reflects the extent to which a medium concentrates electrostatic lines of flux. As would be understood by a person of ordinary skill in the art, relative permittivity is defined as the ratio of force between two charges separated by a certain distance in the medium to the force between the same two charges separated by the same distance in air.

The phrase “dielectric strength” is used herein according to its standard meaning to describe an insulating material and is related to the maximum electric field that a material can withstand without breaking down (i.e., without experiencing failure of its insulating properties) typically reported in kV/cm.

The term “soluble” is used herein to describe the property of an amount of a substance (solute) that dissolves in another substance (solvent) resulting a homogeneous solution. The solubility of a particular amount of a material in another substance can be determined optically, for example by visible inspection. When the solute and solvent liquids are combined in amounts where the resulting liquid solution is clear, the solute is soluble in the solvent in that particular amount. If the mixture is cloudy the solute is considered to be insoluble in the solvent in that particular amount. See also Example 7 disclosed herein.

The phrase “kinematic viscosity,” refers to a measurement of the resistance to flow of a fluid. Many base oils, drilling fluid compositions made from them, and the correct operation of equipment depends upon the appropriate viscosity of the fluid being used. Kinematic viscosity is determined by ASTM D445-06. The results are reported in mm²/s or centistoke.

The term “centistoke,” abbreviated “cSt,” is a unit for kinematic viscosity of a fluid (e.g., a drilling fluid), wherein 1 centistoke equals 1 millimeter squared per second (1 cSt=1 mm²/s). It is also the ratio of the dynamic viscosity of a fluid to the fluid density. See, e.g., ASTM Standard Guide and Test Methods D 2270-04, D 445-06, D 6074, and D 2983.

With respect to describing molecules and/or molecular fragments herein, “Rn,” where “n” is an integer, refers to a hydrocarbon group, wherein the molecules and/or molecular fragments can be linear and/or branched. The term “Cn,” where “n” is an integer, describes a hydrocarbon molecule or fragment (e.g., an alkyl group) wherein “n” denotes the number of carbon atoms in the fragment or molecule.

The phrase “viscosity index” (VI), refers to an empirical, unitless number indicating the effect of temperature change on the kinematic viscosity of the oil. Viscosity index is determined by ASTM D2270-04.

The phrase “hydrolytic stability” is used herein to describe the ability of a material to withstand chemical reaction with water, acids or bases to produce decomposition products. The opposite effect known as “hydrolytic instability” is typically accelerated by high temperature conditions.

The prefix “bio” refers to an association with a renewable resource of biological origin, such as resources generally being exclusive of fossil fuels.

The phrase “internal olefin” refers to an olefin (i.e., an alkene) having a non-terminal carbon-carbon double bond (C═C). This is in contrast to “alpha-olefins” which do bear a terminal carbon-carbon double bond.

The phrase “pour point” refers to the lowest temperature at which a fluid will pour or flow. (See, e.g., ASTM International Standard Test Method D 97). The results are reported in degrees Celsius. Many commercial base oils have specifications for pour point. When base oils have low pour points, the base oils are also likely to have other good low temperature properties, such as low cloud point, and low cold flow viscosity.

The phrase “cloud point” refers to the temperature at which a fluid begins to phase separate due to crystal formation. See, e.g., ASTM Standard Test Methods D 2500.

The term “rheology” refers to the study of deformation and flow of matter. Rheological measurements of a drilling fluid include plastic viscosity (PV), yield point (YP) and gel strengths. The information from these measurements can be used to determine hole cleaning efficiency, system pressure losses, equivalent circulating density, surge and swab pressures and bit hydraulics.

The phrase “fluid loss control agent” includes, but is not limited to, asphaltics (e.g., asphaltenes and sulfonated asphaltenes), amine treated lignite, and gilsonite. For drilling fluids intended for use in high temperature environments (e.g., where the bottom hole temperature exceeds about 204.4° C. (400° F.)), the fluid loss control agent is preferably a polymeric fluid loss control agent. Exemplary polymeric fluid loss control agents include, but are not limited to, polystyrene, polybutadiene, polyethylene, polypropylene, polybutylene, polyisoprene, natural rubber, butyl rubber, polymers consisting of at least two monomers selected from the group consisting of styrene, butadiene, isoprene, and vinyl carboxylic acid. Individual or mixtures of polymeric fluid loss control agents can be used in the drilling fluid of this invention.

The phrase “organophilic clay” or “viscosifiers”, includes but is not limited to organophilic bentonite, hectorite, attapulgite and sepiolite. An example of organophilic clay is CARBO-GEL II (Baker-Hughes). Bentonite and hectorite are platelet clays that will increase viscosity, yield point and build a thin filter cake to aid in reducing the fluid loss. A number of polymers are available for use in non-aqueous fluids. These polymers increase fluid carrying capacity and may also function as fluid loss control additives. They include: elastomeric viscosifiers, sulfonated polystyrene polymers, styrene acrylate, fatty acids and dimer-trimer acid combinations.

The term “emulsifier” includes but is not limited to primary and secondary emulsifiers. Primary emulsifiers are generally very powerful, fatty acid based surfactants. They usually require lime to activate and build a stable emulsion. Secondary emulsifiers, often called wetting agents, are typically based on imidazolines or amides (e.g., OMNI-MUL®, Baker-Hughes), and typically do not require lime to activate. They are designed to oil-wet solids and also emulsify oil.

The term “shale stabilizing salt,” refers to an ionic compound typically used to make drilling fluids, completion fluids, or brines with a suitable density. Emulsification of CaCl₂ brine, as the internal phase of synthetic-based fluid is an important use because the shale stabilizing salt enhances wellbore stability while drilling water-sensitive shale zones. Calcium chloride is the most predominantly used shale stabilizing salt although sodium chloride, sea water, and other brines are occasionally used.

The phrase “weighting agents”, refers to materials, such as barite (barium sulfate), used to increase the density of drilling fluids. Other weighting agents are hematite (iron oxide), manganese tetraoxide and calcium carbonate.

The phrase “latex filtration control agent”, refers to a liquid form of Pliolite® (Goodyear) polymers.

The phrase “simulated drill solids,” refers to powdered clay as used to simulate drilled formation particles.

The phrase “non-organophilic clay,” refers to a clay which has not been amine-treated to convert the clay from water-yielding to oil-yielding.

The phrases “fluid weight” or “fluid density”, refers to a fluid property for balancing and controlling downhole formation pressures and promoting wellbore stability. Mud densities are usually reported in pounds per gallon (lb/gal). As most drilling fluids contain at least a little air/gas, the most accurate way to measure the density is with a pressurized fluid balance.

The term “alkali salt,” includes lime (quicklime (CaO), quicklime precursors, and hydrated quicklime (e.g., slaked lime (CaOH₂))), sodium hydroxide, potassium hydroxide, and magnesium hydroxide.

The term “surfactant,” refers to substances that when present at low concentration in a system, have the property of adsorbing onto the surfaces or interfaces of the system and of altering to a marked degree the surface or interfacial free energies of those surfaces (or interfaces). As used in the foregoing definition of surfactant, the term “interface” indicates a boundary between any two immiscible liquid phases and the term “surface” denotes an interface where one phase is generally a solid and the other phase is a liquid. To formulate stable water-in-oil mixtures, the use of surfactants is required. Surfactants lower surface tension and emulsify the internal water phase and “oil wet” solids.

The term “lubricant,” refers to substances (usually a fluid under operating conditions) introduced between two moving surfaces so to reduce the friction and wear between them.

Unless otherwise indicated herein, scientific and technical terms used in connection with the present invention shall have the meanings that are commonly understood by those of ordinary skill in the art. Further, unless otherwise required by context, singular terms shall include pluralities and plural terms shall include the singular. More specifically, as used in this specification and the appended claims, the singular forms “a”, “an” and “the” include plural references unless the context clearly dictates otherwise. Thus, for example, reference to “an ester” includes a plurality of esters, and the like. In addition, ranges provided in the specification and appended claims include both end points and all points between the end points. Therefore, a range of 2.0 to 3.0 includes 2.0, 3.0 and all points between 2.0 and 3.0, such as 2.5, 2.37, and so on. Furthermore, all numbers expressing quantities, percentages or proportions, and other numerical values used in the specification and claims, are to be understood as being modified in all instances by the term “about”. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### Drilling Fluid Compositions

### Base Fluid Solutions

The esters for use with the pulse power drilling fluid embodiments described herein are i) characterized by low viscosity at a temperature of 40° C. of about 40 cSt or less, e.g., from about 2 cSt to about 8 cSt, to about 6 cSt or to about 4 cSt; and ii) are compatible with the alkylene carbonate described herein, to the extent that the alkylene carbonate is soluble in the ester.

Preferably, the ester is selected from esters that are hydrolytically stable when exposed to alkali or elevated temperatures. Hydrolytic stability is evaluated by methods known in the art, for example, by the protocol described in Example 3, below.

In certain embodiments, the ester (or a mixture thereof) has a molecular weight (or an average molecular weight or mass) that is from about 144 grams/mole to about 592 grams/mole.

Preferably, the ester is selected from esters that have a pour point less than about −20° C., −30° C., −40° C. or −50° C. Alternatively, the mixture of esters has a pour point of less than about −20° C., −30° C., −40° C. or −50° C.

Further embodiments are directed to a pulse power drilling fluid wherein the base oil solution has a kinematic viscosity at about 40° C. between about 0 cSt to about 15 cSt, preferably between about 0 cSt to about 10 cSt, or more preferably between about 0 cSt to about 8 cSt.

Example embodiments are described herein, wherein the pulse power drilling fluid has a pour point less than about 10° C. and wherein the base oil has a viscosity at 40° C. between about 1 cSt to about 10 cSt.

Example embodiments described herein are directed to a drilling fluid wherein the ester and the alkylene carbonate are present in a volume/volume ratio wherein the ester and the alkylene carbonate, after being mixed, do not separate upon standing at room temperature for 24 hours, as set forth in Example 8. Such a mixture where the alkylene carbonate solute is completely soluble in the ester solvent is termed a “solution.” Any separation of the alkylene carbonate from the ester may be visibly evaluated, for example, by the protocol described in Example 7, below. Drilling fluids that comprise an ester and alkylene carbonate that separate upon standing result in a poor drilling fluid characterized, for example, by unacceptably high viscosity.

Example drilling fluid embodiments described herein include a base oil solution wherein the alkylene carbonate and ester are present in a volume/volume ratio of about 5 to about 95 (i.e., 5/95), about 10 to about 90, about 15 to about 85, about 20 to about 80, about 25 to about 75, about 30 to about 70, about 35 to about 65 or about 40 to about 60. In a particular embodiment, the volume/volume ratio of alkylene carbonate to ester is 20/80.

In exemplified embodiments, the amount of ester present in the base oil solution by volume is in a range from about 60% to about 95%, from about 65% to about 90%, from about 70% to about 85%, from about 78% to about 82%, or any range there between.

In exemplified embodiments, the amount of alkylene carbonate present in the base oil solution by volume is in a range from about 5% to about 40%, from about 10% to about 25%, from about 15% to about 30%, or from about 20% to about 25%, or any range there between.

In particular embodiments of the pulse power drilling fluid, the amount of alkylene carbonate present in the base oil solution is a minimum amount sufficient to impart one or more of the following characteristics on a drilling fluid comprised thereof: i) a dielectric constant of about 6 or greater, ii) a conductivity of about 10⁻⁵ mho/cm or less; and iii) a dielectric strength of about 300 kV/cm or greater. In some embodiments, the amount of alkylene carbonate is present in an amount sufficient to provide a drilling fluid with a dielectric constant of about 6 or greater, about 8 or greater, about 10 or greater, or between about 9 and about 10.

In some embodiments, the alkylene carbonate and the ester are present in a volume/volume ratio of about 20 to about 80 wherein the alkylene carbonate is soluble in the ester. In some embodiments, the alkylene carbonate is provided in a maximum amount, but just below the amount in which a visible separation is observed if the mixture of alkylene carbonate is mixed and allowed to sit at room temperature. In some embodiments the alkylene carbonate is present in a maximum amount wherein the alkylene carbonate is 100% soluble in a given volume of ester.

In some embodiments the ester (or mixture thereof) is present in the drilling fluid in an amount (percent by weight of the total weight of the drilling fluid) from about 40% to about 95%, for example, in an amount of at least about 65%, at least about 70%, at least about 75%, at least about 80%, at least about 85% or at least about 90%.]

In some embodiments, the alkylene carbonate is selected from C₂-C₉ alkylene carbonates, i.e., alkylene carbonates having from 2 to 9 carbons. In some embodiments the alkylene carbonate is cyclic, straight chained or branched. In some embodiments the alkylene carbonate is selected from the group consisting of ethylene carbonate, propylene carbonate, butylene carbonate, pentylene carbonate and hexylene carbonate.

Example embodiments described herein are directed to a drilling fluid wherein the base oil solution is between about 95 wt % to about 30 wt % of the drilling fluid. In some embodiments, the base oil solution is between about 90 wt % to about 50 wt % of the drilling fluid. In some embodiments, the base oil solution is between about 80 wt % to about 60 wt % of the drilling fluid.

Example embodiments described herein are directed to a drilling fluid, wherein the drilling fluid further comprises one or more additives generally known in the art that do not detract from the inventive properties of the drilling fluid. Exemplified components include but are not limited to those selected from the group consisting of: (a) lime, (b) a fluid loss control agent, (c) an aqueous solution comprising water and a shale inhibiting salt, (d) an oil wetting agent, (e) organophilic clay, (f), emulsifier, (g) and weighting agent. Example embodiments described herein are directed to a drilling fluid, wherein the drilling fluid further comprises one or more additives selected from the group consisting of: (a) between about 0.5 wt % to about 3.0 wt % of the emulsifier and wetting agent; (b) between about 0.1 wt % to about 1.5 wt % of an organophilic clay; (c) between about 0 wt % to about 12 wt % of water; (d) between about 0.5 wt % to about 4.0 wt % of a shale inhibiting salt; (e) between about 0.3 wt % to about 2 wt % of alkali salt; (f) between about 0.1 wt % to about 1.5 wt % of the fluid loss control agent; (g) between about 2 wt % to about 80 wt % of the weighting agent; and (h) between about 3.0 wt % to about 9.0 wt % of the simulated drill solids.

Example embodiments described herein are directed to a pulse power drilling fluid comprising the base oil solution described herein, wherein the ester is derived from an internal olefin. Example embodiments include wherein the ester is derived from an isomerized olefin. Example embodiments include wherein the ester is derived from a secondary alcohol. Example embodiments include wherein the ester is a secondary monoester. Example embodiments include wherein the base oil solution does not include products derived from oligomerization.

### Monoesters

Example embodiments described herein are directed to a drilling fluid comprising a base oil solution, wherein the ester is an secondary monoester having a structure according to Formula I:

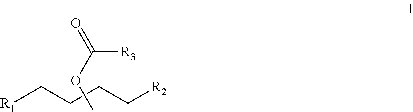

wherein R₁ and R₂ are independently selected from C₁ to C₈ and R₃ is C₅ to C₁₃. As a person of ordinary skill in the art would understand from the above formula I, the oxygen of the ester moity is bonded to any one of the internal carbons on the backbone extending from R₁ to R₂. Specifically, the —O(CO)R₃ group of Formula I is not bound to a terminal carbon of R₁ or R₂.

Example embodiments described herein are directed to a drilling fluid comprising a monoester of Formula I, wherein R₁ and R₂ are independently selected from C₁ to C₈ and R₃ is C₅ to C₁₃; wherein R₁ and R₂ are independently selected from C₁ to C₅ and R₃ is C₅ to C₈; wherein R₁ and R₂ are independently selected from C₁ to C₃ and R₃ is C₅ to C₆.

Example embodiments described herein are directed to a drilling fluid comprising a monoester of Formula I, wherein the kinematic viscosity of the monoester of Formula I at a temperature of 100° C. is between about 0.5 cSt to 2 cSt, a temperature of 40° C. is between about 2 cSt to 4 cSt and a temperature of 0° C. is between about 4 cSt to 12 cSt.

Example embodiments described herein are directed to a drilling fluid comprising a monoester of Formula I, wherein the monoester of Formula I is biodegradable and non-toxic.

Example embodiments described herein are directed to a drilling fluid comprising a monoester of Formula I, wherein the monoester of Formula I is derived from an isomerized olefin.

In example embodiments the monoester of Formula I is i) an octyl-n-yl-hexanoate where n may be 2, 3 or 4; or a mixture thereof (i.e., an isomeric mixture), ii) a decyl-n-yl-hexanoate where n may be 2, 3, 4 or 5, or an isomeric mixture thereof or iii) a mixture of any esters from group i) and group ii).

Example embodiments described herein are directed to a drilling fluid comprising a monoester of Formula I, wherein the drilling fluid comprises a monoester selected from the group consisting of hexanyl hexanoate and isomers, hexanyl octanoate and isomers, hexanyl decanoate and isomers, hexanyl laureate and isomers, hexanyl palmitate and isomers, hexanyl hexadecanoate and isomers, hexanyl stearate and isomers, octanyl hexanoate and isomers, octanyl octanoate and isomers, octanyl decanoate and isomers, octanyl laureate and isomers, octanyl palmitate and isomers, octanyl hexadecanoate and isomers, octanyl stearate and isomers, decanyl hexanoate and isomers, decanyl octanoate and isomers, decanyl decanoate and isomers, decanyl laureate and isomers, decanyl palmitate and isomers, decanyl hexadecanoate and isomers, decanyl stearate and isomers, dodecanyl hexanoate and isomers, dodecanyl octanoate and isomers, dodecanyl decanoate and isomers, dodecanyl laureate and isomers, dodecanyl palmitate and isomers, dodecanyl hexadecanoate and isomers, dodecanyl stearate and isomers, tetradecanyl hexanoate and isomers, tetradecanyl octanoate and isomers, tetradecanyl decanoate and isomers, tetradecanyl laureate and isomers, tetradecanyl palmitate and isomers, tetradecanyl hexadecanoate and isomers, tetradecanyl stearate and isomers, hexadecanyl hexanoate and isomers, hexadecanyl octanoate and isomers, hexadecanyl decanoate and isomers, hexadecanyl laureate and isomers, hexadecanyl palmitate and isomers, hexadecanyl hexadecanoate and isomers, hexadecanyl stearate and isomers, octadecanyl hexanoate and isomers, octadecanyl octanoate and isomers, octadecanyl decanoate and isomers, octadecanyl laureate and isomers, octadecanyl palmitate and isomers, octadecanyl hexadecanoate and isomers, octadecanyl stearate and isomers, icosanyl hexanoate and isomers, icosanyl octanoate and isomers, icosanyl decanoate and isomers, icosanyl laureate and isomers, icosanyl palmitate and isomers, icosanyl hexadecanoate and isomers, icosanyl stearate and isomers, docosanyl hexanoate and isomers, docosanyl octanoate and isomers, docosanyl decanoate and isomers, docosanyl laureate and isomers, docosanyl palmitate and isomers, docosanyl hexadecanoate and isomers and docosanyl stearate and isomers, and mixtures thereof.

Alternatively, monoesters suitable for use with the present pulse power drilling fluids are secondary monoesters characterized by having a structure according to Formula II:

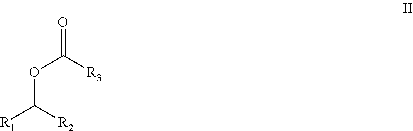

wherein R₁ and R₂ are independently selected from the group consisting of linear alkyls having a number of carbons ranging from 1 to 15, 1 to 8, or 1 to 5; wherein n is the sum of the carbons in R₁ and R₂ and n ranges from 4 to 30, from 4 to 20; from 5 to 15 or from 6 to 10; and wherein R₃ is independently selected from the group consisting of branched or linear alkyl groups having a number of carbons ranging from 3 to 13, from 4 to 10 or from 5 to 8. In a particular embodiment, R₃ is a linear alkyl.

In certain embodiments, the monoester is an isomeric mixture of monoesters according to Formula II, wherein each monoester comprising the isomeric mixture has the same molecular weight, R₃ group and value of n. In certain embodiments, the isomeric mixture of monoesters n is 3, 4, 5, 6, 7, 8, 9, or 10.

In a particular embodiment, the monoester is an isomeric mixture of monoesters according to Formula II having the same molecular weight, wherein R₃ is a linear alkyl having 5 carbons and n is 7. That is to say that the monoesters of the isomeric mixture are selected from the group consisting of: octan-2-yl hexanoate; octan-3-yl hexanoate; and octan-4-yl hexanoate illustrated below. In certain embodiments, the isomeric mixture of monoesters consists of a mixture of all three of the internal isomers of octan-n-yl hexanoate, illustrated below. In additional embodiments, the isomeric mixture of monoesters wherein n is 7 optionally include octan-1-yl hexanoate present in small amounts, e.g., less than 5%, less than 3% or less than 1% by weight of the total monoesters of Formula II.

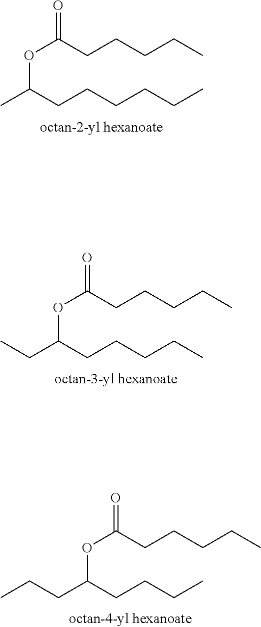

In certain embodiments, each monoester of the isomeric mixture is present in an amount of at least 5%, at least 10%, at least 15%, at least 20%, at least 25%, at least 30%, at least 35%, at least 45%, or at least 50% of the total monoesters present in the base oil solution.

In certain embodiments, the pour point of the monoester of Formula I, the monoester of Formula II, or the isomeric mixture of monoesters according to Formula II is less than −20° C., −30° C., −40° C., −50° C., or −60° C.

Certain embodiments are directed to a base oil solution described herein comprising less than 5%, less than 3% or less than 1% by weight, of a primary monoester. In a particular embodiment, the base oil solution comprises less than 3% of a primary monoester.

In a particular embodiment, the base oil solution composition described herein comprises less than 3%, or alternatively, less than 1% by weight, of a primary monoester according to Formula III

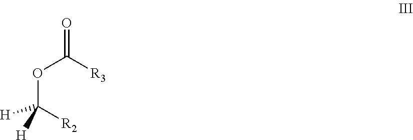

wherein R₂ is selected from the group consisting of linear alkyls having a number of carbons ranging from 1 to 15, 1 to 8, or 1 to 5; and wherein R₃ is independently selected from the group consisting of branched or linear alkyl groups having a number of carbons ranging from 3 to 13, from 4 to 10 or from 5 to 8. In a particular embodiment, R₃ is a linear alkyl.

Depending on the embodiment, the monoesters of the isomeric mixture of monoesters have a molecular weight between 144 g/mol and 592 g/mol.

In some embodiments, such above-described base oil solutions are substantially homogeneous in terms of the n value of the isomeric mixture of monoesters. That is, the sum of R₁ and R₂ for the at least 90% of the monoesters in the mixture have the same n value. In additional embodiments, the above-described base fluids comprise more than one isomeric mixture of monoesters, wherein the sum of R₁ and R₂ for monoesters of Formula II is two or more different n values. For example, at least 10% by weight of the monoesters of Formula II have n=6, at least 10% by weight of the monoesters of Formula II have n=7, at least 10% by weight of the monoesters of Formula II have n=8, and/or at least 10% by weight of the monoesters of Formula II have n=9.

Example embodiments described herein are directed to base oil solutions comprising an isomeric mixture of monoesters according to Formula II, wherein the kinematic viscosity of the isomeric mixture of monoesters according to Formula II at a temperature of 100° C. is between about 0.5 cSt to 2 cSt, at a temperature of 40° C. is between about 2 cSt to 4 cSt and at a temperature of 0° C. is between about 4 cSt to 12 cSt.

Example embodiments described herein are directed to a base oil solution comprising an isomeric mixture of monoesters according to Formula II, wherein the isomeric mixture of monoesters is biodegradable and non-toxic as established by the 275-day anaerobic biodegradation test and the sediment toxicity test, respectively.

Example embodiments described herein are directed to a base oil solution comprising an isomeric mixture of monoesters according to Formula II, wherein the isomeric mixture of monoesters is derived from an isomerized olefin.

Example embodiments described herein are directed to a base oil solution comprising an isomeric mixture of secondary monoesters according to Formula II wherein n is 7, that is, a mixture of the internal isomers of octyl hexanoate; or wherein n is 9, that is, a mixture of isomers of decyl hexanoate.

Example embodiments described herein are directed to a pulse power drilling fluid comprising “octan-n-yl hexanoate”, an internal monoester derived from a fatty acid and a normal olefin and has a low viscosity of 2.14 cSt at 40° C. The octan-n-yl hexanoate used in the Examples provided herein corresponds to a mixture of mainly octan-2-yl hexanoate, octan-3-yl hexanoate, and octan-4-yl hexanoate with very little octan-1-yl hexanoate. Alternatively, the octan-n-yl hexanoate base oil solution can be described as an isomeric mixture of secondary monoesters according to Formula II wherein n is 7.

### Diesters

Example embodiments described herein are directed to a drilling fluid comprising a neopentyl diester. In exemplified embodiments, the neopentyl diester is neopentyl glycol di heptanoate. In exemplified embodiments the neopentyl glycol di heptanoate is sold under the trade name INOLEX LEXOLUBE 21-214®. In some embodiments the neopentyl glycol di heptanoate has one or more of the following characteristics: a viscosity of 5.6 cSt at 40° C., a pour point of −60° C., a flash point of 178° C., and a specific gravity of 0.91.

### Neopentyl Polyol Esters

The term “neopentyl polyol esters” as used herein refers to esters made by reacting monobasic acids with polyhydric alcohols having a neopentyl structure. The unique feature of the structure of neopentyl polyol ester molecules is the fact that there are no hydrogens on the beta-carbon. Since this “beta-hydrogen” is the first site of thermal attack on polyol esters, eliminating this site substantially elevates the thermal stability of neopentyl polyol esters and allows them to be used at much higher temperatures. In addition, neopentyl polyol esters have more ester groups than the diesters and this added polarity further reduces volatility, enhances the lubricity characteristics and improves the solubility of alkylene carbonates in these esters while retaining all the other desirable properties inherent with diesters. This makes neopentyl polyol esters ideally suited for higher temperature applications.

Example embodiments described herein are directed to a drilling fluid comprising a neopentyl polyol ester sold under the trade name EMERY DEHYLUB 4022®. Dehylub 4022 is a polyol ester made by reacting a mixture of nC₈ and nC₁₀ fatty acids with trimethylol propane, also referred to as TMP C8C10. Trimethylol propane has three hydroxyl groups. In other embodiments the EMERY DEHYLUB 4022® has one or more of the following characteristics: a viscosity at 40° C. of about 17-20 cSt, a pour point of −40° C., a flash point of about 250° C., and a density of about 0.945 s/cc.

### Drilling Fluid Additives

Example embodiments described herein are directed to a drilling fluid comprising one or more of the following: Surfactants (e.g., emulsifiers, wetting agents), viscosifiers, weighting agents, fluid loss control agents, alkali salts and shale inhibiting salts. Because the drilling fluids according to the disclosed embodiments are intended to be non-toxic, these optional ingredients are preferably also non-toxic. Exemplary emulsifiers include, but are not limited to, fatty acids, soaps of fatty acids, and fatty acid derivatives including amido-amines, polyamides, polyamines, esters (such as sorbitan monoleate polyethoxylate, sorbitan dioleate polyethoxylate), imidazolines, and alcohols.

Typical wetting agents include, but are not limited to, lecithin, fatty acids, crude tall oil, oxidized crude tall oil, organic phosphate esters, modified imidazolines, modified amidoamines, alkyl aromatic sulfates, alkyl aromatic sulfonates, and organic esters of polyhydric alcohols.

Exemplary weighting agents include, but are not limited to barite, iron oxide, galena, siderite, and calcium carbonate. Typically, the concentration of the weighting agent is 100-700 lbs/bbl.

Common shale inhibiting salts are alkali metal and alkaline-earth metal salts. Calcium chloride and sodium chloride are the preferred shale inhibiting salts.

Common alkali salts are quick lime (CaO) and slaked lime (Ca(OH)₂).

Exemplary viscosifiers include, but are not limited to, organophilic clays (e.g., amine treated hectorite, bentonite, and attapulgite), non-organophilic clays (e.g., montmorillonite (bentonite), hectorite, saponite, attapulgite, and illite), oil soluble polymers, polyamide resins, and polycarboxylic acids and soaps. The typical concentration of viscosifiers, e.g., organophilic clay, is 0 to 15 lbs/bbl.

Examples of fluid loss control agents include, but are not limited to, asphaltics (e.g., asphaltenes and sulfonated asphaltenes), amine treated lignite, and gilsonite. The typical concentration of fluid loss control agents is 2 to 20 lbs/bbl. For drilling fluids intended for use in high temperature environments (e.g., where the bottom hole temperature exceeds about 204.4° C. (400° F.)), the fluid loss control agent is preferably a polymeric fluid loss control agent. Exemplary polymeric fluid loss control agents include, but are not limited to, polystyrene, polybutadiene, polyethylene, polypropylene, polybutylene, polyisoprene, natural rubber, butyl rubber, polymers consisting of at least two monomers selected from the group consisting of styrene, butadiene, isoprene, and vinyl carboxylic acid. Individual or mixtures of polymeric fluid loss control agents can be used in the drilling fluid of this invention. The typical concentration of polymeric fluid loss control agents is 0.05 to 15 lbs/bbl.

Optionally, one or more pour point depressants are employed in the drilling fluids according to the example embodiments disclosed herein to lower their pour point. Typical pour point depressants include, but are not limited to, ethylene copolymers, isobutylene polymers, polyalkylnaphthalenes, wax-aromatic condensation products (e.g., wax-naphthalene condensation products, phenol-wax condensation products), polyalkylphenolesters, polyalkylmethacrylates, polymethacrylates, polyalkylated condensed aromatics, alkylaromatic polymers, iminodiimides, and polyalkylstyrene. (The molecular weights for polyaklylnaphthalenes, polyalkylphenolesters, and polyalkylmethacrylates range from about 2,000 to about 10,000). Because they are non-toxic, ethylene copolymers and isobutylene polymers are the preferred pour point depressants. Up to about 1 weight percent pour point depressant is employed. (As used in the specification and claims, the weight percent of the pour point depressant is based upon the weight of the monoester, i.e., it is the weight of the pour point depressant divided by the weight of the monoester, the quotient being multiplied by 100%.) Preferably, the pour point depressant is employed in a concentration of 0.005 to about 0.5, more preferably about 0.01 to about 0.4, and most preferably about 0.02 to about 0.3, weight percent. When employed, the pour point depressant is preferably mixed with the monoester and the resulting composition is then combined with any additional additives as described herein.

The properties (e.g., ester/alkylene carbonate base oil solution to water ratio, density, etc.) of the drilling fluids according to the example embodiments disclosed herein can be adjusted to suit any pulse power drilling operation. For example, the drilling fluid is usually formulated to have a volumetric ratio of ester/alkylene carbonate base oil solution to water of about 100:0 to about 40:60 and a density of about 0.9 kg/l (7.5 pounds per gallon (ppg)) to about 2.4 kg/l (20 ppg). More commonly, the density of the drilling fluid is about 1.1 kg/l (9 ppg) to about 2.3 kg/l (19 ppg). The drilling fluids are preferably prepared by mixing the constituent ingredients in the following order: (a) ester/alkylene carbonate base oil solution, (b) emulsifier, (c) lime (when employed), (d) fluid loss control agent (when employed), (e) an aqueous solution comprising water and the shale inhibiting salt, (f) organophilic clay, (g) oil wetting agent, (h) weighting agent, (i) non-sulfonated polymer (when employed), (j) sulfonated polymer (when employed), and (k) non-organophilic clay (when employed).

### Methods of Using the Drilling Fluids

Example embodiments described herein are directed to methods of drilling a borehole in a substrate comprising: providing an electrocrushing drill comprising a drill bit that receives a pulsed electric current; introducing a drilling fluid into the borehole and through the drill bit; and breaking the substrate with the pulsed electric current; wherein the drilling fluid is any pulse power drilling fluid composition according to the example embodiments disclosed herein that comprise a base oil solution made up of an alkylene carbonate and an ester having a kinematic viscosity at a temperature of 40° C. of about 40 cSt or less, wherein the alkylene carbonate is present in an amount that is soluble in the ester; and wherein the drilling fluid has one or more of the following characteristics: i) a dielectric constant of 6 or greater, ii) a dielectric strength of 300 kV/cm or greater and iii) a conductivity of 10⁻⁵ mho/cm or less.

As described previously, in certain example embodiments, the electrocrushing drill is different from a conventional rotary drill bit in that it comprises electrodes for delivering a pulsed electric current to the substrate or formation to be crushed. Alternatively, in other example embodiments, the electrocrushing drill can include or work in combination with a conventional rotary drill bit.

### EXAMPLES

The following examples are provided to demonstrate particular embodiments of the pulse power drilling fluids disclosed herein. It should be appreciated by those of skill in the art that the methods disclosed in the examples which follow merely represent exemplary embodiments of the drilling fluids disclosed herein. However, those of skill in the art should, in light of the present disclosure, appreciate that many changes can be made in the specific embodiments described and still obtain a like or similar result without departing from the spirit and scope of the drilling fluids disclosed herein.

### Example 1

### Evaluation of Comparative Drilling Fluids Formulated with Castor Oil—Rheological and Fluid Loss Properties

Castor oil is a triglyceride in which 90% of the fatty acid chains are ricinoleic acid. Oleic and linoleic acids are other components. Castor oil has a viscosity of 259 to 325 cSt at 40° C., a density of 0.96 g/cc, a flash point of 282° C. and a pour point of −20 F. Castor oil has a dielectric constant of 4.45 at 22° C. It has a dielectric strength of greater than 300 kV/cm.

An 80/20 v/v castor oil/butylene carbonate solution has a relative permittivity (dielectric constant) of 15. At greater than 32% butylene carbonate, the butylene carbonate is not soluble in the castor oil and the mixture separates when standing at room temperature. The 80/20 solution absorbs up to 2,000 ppm of water without affecting the dielectric properties. This solution has a kinematic viscosity of 250 cSt at 21° C. (70° F.) and a kinematic viscosity of 100 cSt at 40 C (104° F.). The solution has a freezing point of −26° C., a density of 0.999 g/cc, and a flash point greater than 135° C. The solution has a dielectric strength of 673 kV/cm, measured using 0.75 diameter ball electrodes spaced 0.08 inches apart.

Additives must be added to the castor base oil (80/20 castor oil/butylene carbonate solution) in order to provide a drilling fluid characterized by usable gelation, filtration control, and weighting (densification) for the drilling fluid. A 350 ml lab barrel (bbl) of basic pulse power drilling fluid was formulated using the following components:
316.4 g/bbl base oil solution
15 g/bbl GELTONE® II organophilic clay
12 g/bbl DURATONE® HT fluid loss control additive
76 g/bbl barite

The rheological and fluid loss properties of an 80/20 v/v castor oil/butylene carbonate solution based drilling fluid formulation at 150° F. are shown in the table below:

| | 150° F. |
|---|---|
| Fann dial reading @: 600 RPM | 127 |
| 300 RPM | 70 |
| 200 RPM | 50 |
| 100 RPM | 30 |
| 6 RPM | 7 |
| 3 RPM | 6 |
| Plastic Viscosity, cps @ 150° F. | 57 |
| Yield Point, lb/100 sq ft | 13 |
| 10 sec gel, lb/100 sq ft | 7 |
| 10 min gel, lb/100 sq ft | 9 |
| Electrical Stability @ 150° F. | NA |
| HTHP filtrate @ 250° F., 500 psi | 34.4 |
| Water, mls | 0 |
| Cake thickness, HTHP, 32^{nd} inch | 3.0 |

### Example 2

### Evaluation of Comparative Drilling Fluids Formulated with Castor Oil—Dielectric Strength

In our experience, it is necessary for a pulse power drilling fluid according to the exemplified embodiments to exhibit a minimum dielectric strength of 300 kV/cm, which maximizes performance in the pulse power drilling environment. In order to determine the dielectric strength of a drilling fluid, the breakdown voltage can be evaluated, e.g., using commercially available dielectric strength testers such as Megger Dielectric Tester (5 kV DC), Baur PGK50 (50 kV), Kleanoil HBVT Transformer Oil Dielectric Strength/Breakdown Voltage Tester, Hipotronics OC60D—A Oil Dielectric Tester (60 kV).

The dielectric constant of ethylene carbonate at 40° C. is about 90, the dielectric constant of propylene carbonate at 20° C. is about 64, and the dielectric constant of butylene carbonate at 20° C. is about 57.7. The dielectric constant of an 80/20 v/v solution of castor oil and butylene carbonate at 20° C. is about 15.5. The dielectric constant of a 70/30 v/v solution of castor oil and butylene carbonate at 20° C. is about 21.

The breakdown voltages of 80/20 v/v castor oil/butylene carbonate solution measured on three replicates were 30 kV, 38 kV, and 38 kV (avg 35.3 kV) using 0.01 inch gap spacing and 0.25 inch diameter electrodes. This resulted in an average dielectric strength of 1,393 kV/cm. The breakdown voltage of the basic drilling fluid formulation based on the 80/20 v/v castor oil/butylene carbonate solution with additives was 37 kV with 0.01 inch gap spacing and 0.25 inch diameter electrodes, which resulted in a dielectric strength of 1,458 kV/cm.

The breakdown voltages of the basic drilling fluid formulation based on the 80/20 v/v castor oil/butylene carbonate solution containing 21,000 ppm water contamination (using 0.01 inch gap spacing and 0.25 inch diameter electrodes) measured on three replicates were 14, 36 and 24 kV (avg 24.7 kV), which resulted in a dielectric strength of 973 kV/cm.

Water is believed to be an undesirable contaminant in pulse power drilling fluids because it lowers the breakdown voltage which reduces the efficiency of the pulse power drilling bit. Entrained air bubbles also lower the breakdown voltage and reduce efficiency.

An 80/20 v/v solution of two non-aqueous fluids, castor oil and butylene carbonate, was shown to have high dielectric strength, high dielectric constant, and low conductivity. However, this base oil solution exhibits a prohibitively high kinematic viscosity (100 cSt at 40° C.), which will reduce drilling performance due to excessive lost circulation, low pump rates, high fluid retention on cuttings, and high entrainment of air bubbles (hence, higher viscosity).

A pulse power drilling fluid with a relatively lower viscosity is desired because it offers the following advantages: less occurrence of lost circulation, less drilling fluid is retained on the cuttings going over the shaker screen, less entrainment of air bubbles which interfere with pulse power electric performance, it is easier to build ‘good’ rheology for hole cleaning using organoclays and polymers, and it provides a higher flow rate for a given ECD (equivalent circulating density). Also, the esters for use in the drilling fluids in accordance with the embodiments disclosed herein are hydrolytically stable compared to castor oil.

### Example 3

### Evaluation of Esters—Hydrolytic Stability

10 ml of the ester to be tested was mixed with 20 ml 5N NaOH, stirred 15 mins in a beaker on a hot plate at 85° C., then shaken for 5 minutes in a jar and allowed to sit overnight. The results indicate that there was significantly more hydrolytic degradation (as evidenced by the formation of a gel rather than remaining a liquid) of the base oil comprising PETROFREE® LV (2-ethyl 2-ethylhexanoate) than of the base oil comprising an isomeric mixture of internal isomers of octan-n-yl hexanoate. This embodiment of the isomeric mixture of monoesters corresponds to a mixture of mainly octan-2-yl hexanoate, octan-3-yl hexanoate, and octan-4-yl hexanoate with very little (i.e., 1-3%) octan-1-yl hexanoate.

### Example 4

### Evaluation of Base Oil Mixtures—80/20 Ester/Alkylene Carbonate

Several esters were tested for their ability to solubilize butylene carbonate when blended 80/20 v/v ester/ butylene carbonate. 40 ml of ester was stirred with 10 ml butylene carbonate at room temperature in a beaker. The resulting mixture was optically evaluated where a resulting clear liquid indicated that the butylene carbonate is soluble. Each ester used in the experiment had a much lower viscosity than that of castor oil (259-325 cSt at 40° C.). The results of the test are listed below.

| | | Solubilizes |
|---|---|---|
| | | Butylene |
| Trade Name | Generic Class | Carbonate? |
| DEHYLUB ® 4022 | Polyol ester | Yes |
| octan-n-yl hexanoate | Monoesters | Yes |
| INOLEX LEXOLUBE 2I- | Polyol ester | Yes |
| 214 ® | | |
| DEHYLUB 4018 ® | Fatty acid ester | No |
| DEHYLUB 4002 ® | Fatty acid ester | No |
| DEHYLUB 1330 ® | Neopentyl glycol ester | No |
| DEHYLUB 1324 ® | Ester | No |
| OMC 1000 ® | Fatty acid ester | No |
| OMC 586 XL ® | Palm oil ester | No |
| PETROFREE LV ® | 2-ethylhexyl 2-ethylhexanoate | No |

Surprisingly, EMERY DEHYLUB 4022®, INOLEX LEXOLUBE 21-214® and the octan-n-yl hexanoate completely solubilized butylene carbonate at an 80/20 v/v ratio. The remaining esters, some used in commercial drilling, do not solubilize butylene carbonate at an 80/20 v/v ratio.

Solubility of alkylene carbonate in the ester is critical to the performance of the pulse power drilling fluids disclosed herein. If the fluids are not soluble or only partially soluble, then the high dielectric constant of the alkylene carbonate will not significantly increase the dielectric constant of the base oil mixture, because the continuous phase will only contain ester, which has a relatively low dielectric constant. Furthermore, the drilling fluid additives will not mix well with the base oil components, and the resulting drilling fluid will become too thick to be used for pulse power drilling. This thickening is irreversible. In other words, if all the drilling fluid components are mixed wherein the alkylene carbonate, or a portion thereof, is not dissolved in the ester and the resulting drilling fluid is very thick, the drilling fluid cannot be thinned simply by heating the drilling fluid up above the solubility temperature.

### Example 5

Dielectric Constants Measured—Base Oil Mixtures 80/20 Ester/Alkylene Carbonate

The dielectric constants were measured on base oil/butylene carbonate solutions prepared in Example 4 with a dielectric constant tester. The dielectric constant tester consisted of a capacitance meter and a test cell. The test cell volume was 230 mls. The metal circular discs were 2 inches in diameter, ½ inch thick, and the spacing between the discs was 0.08 inches. The base oil/butylene carbonate solution was poured into the test cell and completely covered the two disks in the cell. The capacitance was measured at room temperature (70° F.) and atmospheric pressure. The capacitance meter was a BK Precision LCR/ESR Meter Model 886. The dielectric constant was calculated by dividing the capacitance of the test fluid by the capacitance of air (i.e. with no fluid present in the same test cell).
80/20 v/v Castor Oil/Butylene Carbonate Solution: 10.59
80/20 v/v Castor Oil/Butylene Carbonate Solution Based Drilling Fluid Containing 42,000 ppm Water: 16.06
80/20 v/v Octan-n-yl Hexanoate/Butylene Carbonate Solution: 9.95
80/20 v/v EMERY DEHYLUB 4022® Polyol Ester/Butylene Carbonate Solution: 9.75
80/20 v/v INOLEX LEXOLUBE 21-214® Polyol Ester/Butylene Carbonate Solution: 9.39

All of these dielectric constants met the criterion of >6 for proper operation of the pulse power drilling equipment. All of the alkylene carbonate/ester solutions exhibited low conductivity due to their non-aqueous characteristic.

### Example 6

### Determination of Solubility of Alkylene Carbonates in Various Solvents and Ratios

The solubility tests were conducted by stirring the base oil solvent and alkylene carbonate solute together for 1 minute. The total volume of liquid prepared was 50 ml and the beaker size was 100 ml. The ratios were determined on a volume/volume basis. After stirring, the opacity of the mixture was observed and recorded. The mixture was placed into a freezer, cooled down to 15° F. and kept in the freezer for 2 hours. The mixture was then removed from the freezer and constantly stirred while warming up to room temperature (70° F.). An observation was made about the opacity of the mixture at 5° F. increments during the warming up period.

Solubilty of Alkylene Carbonate Solutes in Base Oil Solvents

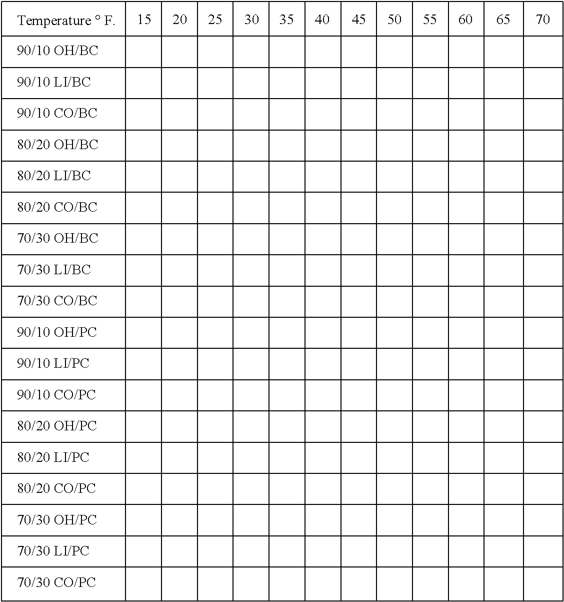

BC = butylene carbonate
PC = propylene carbonate
OH = Octan-n-yl hexanoate
LI = Lexolube 2I-214
CO = castor oil

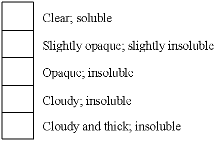

### Example 7

### Preparation of Butylene Carbonate Base Oil Mixtures and Solutions

The solubility experiments were conducted at room temperature in 10 ml capacity test tubes. 3 ml butylene carbonate was added to 7 ml base oil solvent and the mixture was shaken by hand for 2 minutes. After allowing the mixture to sit for 24 hours at room temperature (approx. 20 to 22° C. or 68 to 72° F.), the interface between the liquid phases was determined by visual observation. If there was no interface, the butylene carbonate solute was soluble in the base oil solvent. At the 30/70 ratio, the butylene carbonate was: soluble in Lexolube, soluble in octan-n-yl hexanoate, insoluble in OMC 586 (an interface was observed at the 3 ml mark), and soluble in castor oil.

| | Solubility of 30% | |
|---|---|---|
| Base Oil | Butylene Carbonate | Mixture or Solution |
| LEXOLUBE ® | Soluble | Solution |
| Octan-n-yl Hexanoate, | Soluble | Solution |
| OMC 586 | Not Soluble | Mixture |

### Example 8

### Dielectric Constant and Drilling Fluid Rheology

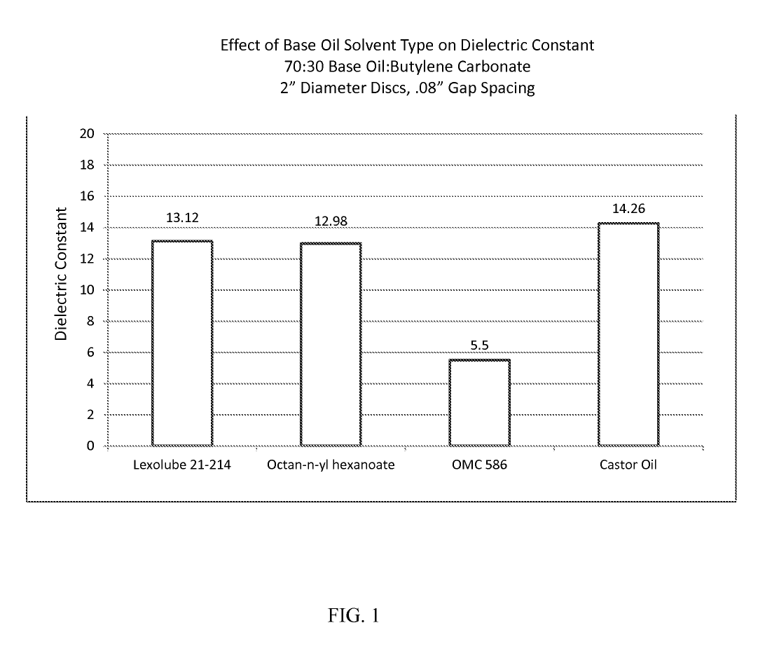

As shown in FIG. 1, the dielectric constants were measured on base oil/butylene carbonate mixtures with a dielectric constant tester. The dielectric constant tester consisted of a capacitance meter and a test cell. The test cell volume was 230 mls. The metal circular discs were 2 inches in diameter, ½ inch thick, and the spacing between the discs was 0.08 inches. The base oil/butylene carbonate mixture was poured into the test cell and completely covered the two disks in the cell. The capacitance was measured at room temperature (70° F.) and atmospheric pressure. The capacitance meter was a BK Precision LCR/ESR Meter Model 886. The dielectric constant was calculated by dividing the capacitance of the test fluid by the capacitance of air (i.e., with no fluid present in the same test cell).

A drilling fluid was prepared by initially agitating 213.5 mls (0.61 volume fraction of a 350 ml “lab barrel”) base oil solvent and 91 mls of butylene carbonate for 1 minute using a blender. Then, the following ingredients were added sequentially, with continuous mixing for 5 minutes after the addition of each material: 15 lbs/bbl GELTONE® II, 12 lbs/bbl DURATONE® HT, 4.6 lbs/bbl LE SUPERMUL®, and 110 lbs/bbl barite. After all ingredients were added, the drilling fluid was sheared for 15 minutes.

The rheological properties were measured at atmospheric pressure and 80° F. in a Fann 35A rheometer. The HTHP fluid loss was measured at 250° F. and 500 psi.

Rheology at 80° F. - 70:30 Base Oil:Butylene Carbonate Volume Ratio

| | Base Oil Solvent | | | |
|---|---|---|---|---|
| | LEXOLUBE ® | octan-n-yl | OMC ® | Castor |
| Property | 2I-214 | hexanoate | 586 | Oil |
| Mud Wt, ppg | 10.38 | 10.01 | 10.10 | 10.54 |
| 600 rpm | 51 | 47 | 135 | Too high |
| | | | | to measure |
| 300 rpm | 29 | 26 | 72 | 188 |
| 200 rpm | 21 | 20 | 52 | 129 |
| 100 rpm | 14 | 13 | 31 | 68 |
| 6 rpm | 5 | 6 | 5 | 8 |
| 3 rpm | 4 | 5 | 4 | 6 |
| PV, cp | 22 | 21 | 63 | Cannot |
| | | | | calculate |
| YP, lbs/100 sqft | 7 | 5 | 9 | Cannot |
| | | | | calculate |
| 10 sec gel | 5 | 6 | 3 | 5 |
| 10 min gel | 7 | 8 | 10 | 6 |
| HTHP fluid loss, | 11.6 | 12.6 | 8.4 | 69 |
| mls (250° F., | | | | |
| 500 psi) | | | | |
| Filter Cake, | 2 | 8 | 8 | 8 |
| 32^{nd} inch | | | | |

Comparison of the solubility, dielectric constant and drilling mud rheologies (including HTHP fluid loss) for 70:30 v/v mixtures with butylene carbonate clearly show the superior performance of the octan-n-yl hexanoate and LEXOLUBE® 21-214 polyol ester compared to OMC 586 (palm oil ester used for rotary drilling) and castor oil.
Only LEXOLUBE® 21-214, octan-n-yl hexanoate and castor oil solubilized the butylene carbonate. Butylene carbonate was completely insoluble in OMC 586.
Only LEXOLUBE® 21-214, octan-n-yl hexanoate and castor oil exhibited suitably high dielectric constants (>6) when blended with 30% butylene carbonate. The 70:30 OMC 586:butylene carbonate mixture dielectric constant was thought to be low because the BC settled out during the measurement. The dielectric constant started at 8.5 and rapidly dropped to 5.5 in the first 2 mins and then stabilized at 5.5 after 2 mins.
The 10 ppg mud rheological properties (notably 600 rpm reading, 300 rpm reading, 200 rpm reading, 100 rpm reading, PV and YP) were either too high or could not be calculated (due to reading being off-scale) with castor oil as the base oil solvent in the 70:30 mixture. In addition, the HTHP fluid loss with castor oil was extremely high at 69 mls. The rheological properties of the OMC 586/butylene carbonate-based mud were also high (but not as bad as with castor oil as the solvent), with a 600 rpm reading of 135 and a PV of 63.

The only base oil solvents that dissolved butylene carbonate, exhibited high dielectric constants with 30% butylene carbonate, and could be formulated into 10 ppg drilling muds having suitable rheological and fluid loss properties were octan-n-yl hexanoate and LEXOLUBE® 21-214.

The present examples support that the base oil solutions prepared from an alkylene carbonate and a low viscosity ester, wherein the alkylene carbonate is soluble in the ester, provide excellent properties for use in pulse-power drilling fluids. In particular, the drilling fluids of the example embodiments described herein have a high dielectric constant, a high dielectric strength, low conductivity, and have a significantly lower viscosity than the current castor oil-based pulse power drilling fluid.

The invention claimed is:

1. A pulse power drilling fluid comprising a base oil solution, the base oil solution comprising:
a) an ester having a kinematic viscosity at a temperature of 40° C. of about 40 cSt or less; and
b) an alkylene carbonate present in an amount wherein the alkylene carbonate is soluble in the ester.

2. The pulse power drilling fluid according to claim 1, wherein the drilling fluid has i) a dielectric constant of about 6 or greater and ii) a conductivity of about 10⁻⁵ mho/cm or less.

3. The pulse power drilling fluid according to claim 1, wherein the drilling fluid has a dielectric strength of about 300 kV/cm or greater.

4. The pulse power drilling fluid according to claim 1, wherein the base oil solution comprises about 60 to 90% of the ester and about 40 to 10% of the alkylene carbonate.

5. The pulse power drilling fluid according to claim 1, wherein the kinematic viscosity of the ester at a temperature of 40° C. is between about 2 cSt to about 8 cSt.

6. The pulse power drilling fluid according to claim 5, wherein the kinematic viscosity of the ester at a temperature of 40° C. is between about 2 cSt to about 4 cSt.

7. The pulse power drilling fluid according to claim 1, wherein the alkylene carbonate is selected from the group consisting of ethylene carbonate, propylene carbonate, butylene carbonate, pentylene carbonate and mixtures thereof.

8. The pulse power drilling fluid according to claim 1, wherein the ester has a pour point of less than about −30° C.

9. The pulse power drilling fluid according to claim 1, wherein the base oil solution has a pour point less than about 10° C.

10. The pulse power drilling fluid according to claim 1, wherein the ester is a neopentyl polyol ester.

11. The pulse power drilling fluid according to claim 10, wherein the neopentyl polyol ester is prepared by reacting a mixture of nC₈ and nC₁₀ fatty acids with trimethylol propane, and wherein the neopentyl polyol ester having a kinematic viscosity at 40° C. between about 17 and about 20 CSt, having a pour point of less than about −30 C, a flash point of greater than about 200° C.

12. The pulse power drilling fluid according to claim 1, wherein the ester is neopentyl glycol diheptanoate.

13. A pulse power drilling fluid comprising a base oil solution consisting of:
a) 60 to 90% by volume of an ester having a kinematic viscosity at a temperature of 40° C. of about 40 cSt or less; and
b) 40 to 10% by volume of an alkylene carbonate selected from ethylene carbonate, propylene carbonate, butylene carbonate, pentylene carbonate and mixtures thereof;
wherein the drilling fluid has i) a dielectric constant of about 6 or greater and ii) a conductivity of about 10⁻⁵ mho/cm or less.

14. The pulse power drilling fluid according to claim 1, wherein the ester is selected from one or more monoesters having a structure according to Formula II: 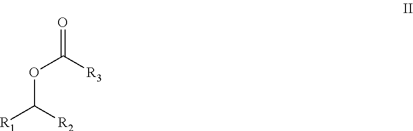
wherein:
R₁ and R₂ are independently selected from the group consisting of linear alkyls having from 1 to 15 carbons, wherein the sum of the number of carbons of R₁ and R₂ is n and wherein n is in the range from 4 to 30; and
R₃ is independently selected from the group consisting of branched or linear alkyls having from 2 to 13 carbons.

15. The pulse power drilling fluid according to claim 14, wherein the ester comprises 5% or less by weight of a primary monoester.

16. The pulse power drilling fluid according to claim 14, wherein n is in the range from 5 to 15 and R₃ is C₅ to C₆.

17. The pulse power drilling fluid according to claim 14, wherein the ester comprises about 50% by volume or more of a mixture of monoesters having the same molecular weight, value of n and R₃.

18. The pulse power drilling fluid according to claim 14, wherein the ester comprises about 90% by volume or more of a mixture of monoesters having the same molecular weight, value of n and R₃.

19. The pulse power drilling fluid according to claim 16, wherein n is 7 and R₃ is 5.

20. The pulse power drilling fluid according to claim 16, wherein n is 9 and R₃ is 5.

21. The pulse power drilling fluid according to claim 1 further comprising one or more additives selected from the group consisting of:
a) between about 0.5 wt % to about 3.0 wt % of the emulsifier and wetting agent;
b) between about 0.1 wt % to about 1.5 wt % of an organophilic clay;
c) between about 0 wt % to about 12 wt % of water;
d) between about 0.5 wt % to about 4.0 wt % of a shale inhibiting salt;
e) between about 0.3 wt % to about 2 wt % of alkali salt;
f) between about 0.1 wt % to about 1.5 wt % of the fluid loss control agent;
g) between about 2 wt % to about 80 wt % of the weighting agent; and
h) between about 3.0 wt % to about 9.0 wt % of the simulated drill solids.

22. A method of pulse power drilling a borehole in a substrate comprising:
a) providing an electrocrushing drill comprising a drill bit that receives a pulsed electric current;
b) introducing a drilling fluid into the borehole and through the drill bit; and
c) breaking the substrate with the pulsed electric current;
wherein the drilling fluid is the drilling fluid of claim 1.

23. The method of pulse power drilling according to claim 22, wherein the drilling fluid has i) a dielectric constant of about 6 or greater; and ii) a conductivity of about 10⁻⁵ mho/cm or less.

24. The method of pulse power drilling according to claim 22, wherein the drilling fluid has a dielectric strength of about 300 kV/cm or greater.

25. The method of pulse power drilling according to claim 22, wherein the base oil solution comprises about 60 to 90% of the ester and about 40 to 10% of the alkylene carbonate.

26. The method of pulse power drilling a borehole according to claim 22, wherein the kinematic viscosity of the ester at a temperature of 40° C. is between about 2 cSt to about 8 cSt.

27. The method of pulse power drilling according to claim 22, wherein the kinematic viscosity of the ester at a temperature of 40° C. is between about 2 cSt to about 4 cSt.

28. The method of pulse power drilling according to claim 22, wherein the alkylene carbonate is selected from the group consisting of ethylene carbonate, propylene carbonate, butylene carbonate, pentylene carbonate and mixtures thereof.

29. The method of pulse power drilling according to claim 22, wherein ester has a pour point less than about −30° C.

30. The method of pulse power drilling according to claim 22, wherein the base oil solution has a pour point less than about 10° C.

31. The method of pulse power drilling according to claim 22, wherein the ester is a neopentyl polyol ester.

32. The method of pulse power drilling according to claim 31, wherein the neopentyl polyol ester is prepared by reacting a mixture of nC₈ and nC₁₀ fatty acids with trimethylol propane, and wherein the neopentyl polyol ester having a kinematic viscosity at 40° C. between about 17 and about 20 CSt, having a pour point of less than about −30 C, a flash point of greater than about 200° C.

33. The method of pulse power drilling 22, wherein the ester is neopentyl glycol diheptanoate.

34. A method of pulse power drilling a borehole in a substrate comprising:
a) providing an electrocrushing drill comprising a drill bit that receives a pulsed electric current;
b) introducing a pulse power drilling fluid into the borehole and through the drill bit; and
c) breaking the substrate with a pulsed electric current;
wherein the pulse power drilling fluid comprises a base oil solution consisting of:
d) 60 to 90% by volume of an ester having a kinematic viscosity at a temperature of 40° C. of about 40 cSt or less; and
e) 40 to 10% by volume of an alkylene carbonate selected from ethylene carbonate, propylene carbonate, butylene carbonate, pentylene carbonate and mixtures thereof;
wherein the drilling fluid has i) a dielectric constant of about 6 or greater; and ii) a conductivity of about 10⁻⁵ mho/cm or less.

35. The method of pulse power drilling according to claim 22, wherein the ester is selected from one or more monoesters having a structure according to Formula II: 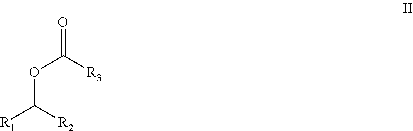
wherein:
R₁ and R₂ are independently selected from the group consisting of linear alkyls having from 1 to 15 carbons, the sum of the number of carbons of R₁ and R₂ is n, and n is in the range from 4 to 30; and
R₃ is independently selected from the group consisting of branched or linear alkyls having from 2 to 13 carbons.

36. The method of pulse power drilling according to claim 35, wherein the ester comprises 5% or less by weight of a primary monoester.

37. The method of pulse power drilling according to claim 35, wherein n is in the range from 5 to 15 and R₃ is C₅ to C₆.

38. The method of pulse power drilling according to claim 35, wherein the ester comprises greater than about 50% by volume or more of a mixture of monoesters having the same molecular weight, value of n and R₃.

39. The method of pulse power drilling according to claim 35, wherein the ester comprises 90% by volume or more of a mixture of monoesters having the same molecular weight, value of n and R₃.

40. The method of pulse power drilling according to claim 37, wherein n is 7 and R₃ is 5.

41. The method of pulse power drilling according to claim 37, wherein n is 9 and R₃ is 5.

42. The method of pulse power drilling according to claim 34, further comprising one or more additives selected from the group consisting of:
a) between about 0.5 wt % to about 3.0 wt % of the emulsifier and wetting agent;
b) between about 0.1 wt % to about 1.5 wt % of an organophilic clay;
c) between about 0 wt % to about 12 wt % of water;
d) between about 0.5 wt % to about 4.0 wt % of a shale inhibiting salt;
e) between about 0.3 wt % to about 2 wt % of alkali salt;
f) between about 0.1 wt % to about 1.5 wt % of the fluid loss control agent;
g) between about 2 wt % to about 80 wt % of the weighting agent; and
h) between about 3.0 wt % to about 9.0 wt % of the simulated drill solids.
